(19) United States
(12) Patent Application Publication
(10) Pub. No.: US 2019/0093015 A1
(43) Pub. Date: Mar. 28, 2019

(54) COMPOSITION, LIQUID CRYSTAL PANEL, LIQUID CRYSTAL DISPLAY DEVICE AND ELECTRONIC DEVICE

(71) Applicant: SHARP KABUSHIKI KAISHA, Sakai City, Osaka (JP)

(72) Inventors: MASAKAZU KAMURA, Sakai City (JP); TAKASHI KATAYAMA, Sakai City (JP); EMI YAMAMOTO, Sakai City (JP)

(21) Appl. No.: 16/083,216

(22) PCT Filed: Mar. 9, 2017
(86) PCT No.: PCT/JP2017/009443

§ 371 Date: Sep. 7, 2018

(30) Foreign Application Priority Data
Mar. 9, 2016 (JP) 2016-046124

(51) Int. Cl. C09K 19/56; C08J 3/28; G02F 1/1337

(52) U.S. Cl. CPC C09K 19/56; G02F 1/133723; C08J 3/28

(57) ABSTRACT

A composition containing a photosensitive polymer in which the molecular structure changes due to absorption of light or a precursor of the photosensitive polymer and an additive that absorbs at least ultraviolet rays and that provides the energy of the absorbed ultraviolet rays to the photosensitive polymer, wherein the photosensitive polymer absorbs at least some of the ultraviolet rays when specifically polarized ultraviolet rays are irradiated as the light so as to undergo a first reaction that generates anisotropy in the molecular alignment of the photosensitive polymer in accordance with the polarization direction of the polarized light and a second reaction that further enhances the anisotropy generated in the molecular alignment of the photosensitive polymer by the first reaction, and the additive absorbs the irradiated ultraviolet rays so as to convert the ultraviolet rays to energy for causing the second reaction and provide the resulting energy to the photosensitive polymer.

### TECHNICAL FIELD

Some aspects of the present invention relate to a composition, a liquid crystal panel, a liquid crystal display device, and an electronic device. The present invention contains subject matter related to Japanese Patent Application No. 2016-046124 filed in the Japan Patent Office on Mar. 9, 2016, the entire contents of which are incorporated herein by reference.

### BACKGROUND ART

In recent years, a film that is formed by using a material for forming an alignment film and that is subjected to alignment treatment by being irradiated with polarized light is known as an alignment film to be used for a liquid crystal panel (refer to, for example, PTLs 1 and 2). In PTLs 1 and 2, the material for forming an alignment film is irradiated with polarized light of an electromagnetic wave, for example, ultraviolet rays, and, thereby, a photochemical reaction in accordance with an oscillation direction of the polarized light is generated in the material for forming an alignment film. As a result, an anisotropic difference in an intermolecular force is generated in the film and an alignment film is produced so as to align liquid crystal molecules.

### CITATION LIST

### Patent Literature

PTL 1: Japanese Patent No. 5034977

PTL 2: Japanese Patent No. 4504665

### SUMMARY OF INVENTION

### Technical Problem

However, according to PTL 1 described above, for the purpose of forming a high-performance alignment film, it is preferable that visible light be irradiated in addition to polarized-light irradiation so as to cause alignment during formation of the alignment film. Meanwhile, according to PTL 2, for the purpose of forming a high-performance alignment film, at least one secondary processing of heating, infrared irradiation, far-infrared irradiation, electron beam irradiation, and radiation irradiation is necessary in addition to polarized-light irradiation so as to cause alignment.

As described above, according to the technology described in PTLs 1 and 2, it is difficult to simply obtain an alignment film having predetermined alignment performance, and an improvement has been desired.

Some aspects of the present invention were realized in consideration of such circumstances, and it is an object to provide a composition capable of readily forming an alignment film that has a high alignment regulation force. Also, it is an object to provide a high-performance liquid crystal panel including an alignment film formed of such a composition. It is also an object to provide a liquid crystal display device and an electronic device that include such a liquid crystal panel.

### Solution to Problem

In order to address the above-described problems, an aspect of the present invention provides a composition containing a photosensitive polymer in which the molecular structure changes due to absorption of light or a precursor of the photosensitive polymer and an additive that absorbs at least ultraviolet rays and that provides the energy of the absorbed ultraviolet rays to the photosensitive polymer, wherein the photosensitive polymer absorbs at least some of the ultraviolet rays when specifically polarized ultraviolet rays are irradiated as the light so as to undergo a first reaction that generates anisotropy in the molecular alignment of the photosensitive polymer in accordance with the polarization direction of the polarized light and a second reaction that further enhances the anisotropy generated in the molecular alignment of the photosensitive polymer by the first reaction, and the additive absorbs the irradiated ultraviolet rays so as to converts the ultraviolet rays to energy for causing the second reaction and provides the resulting energy to the photosensitive polymer.

In the configuration of an aspect of the present invention, the additive may absorb light in a first wavelength band, convert the absorbed light in the first wavelength band to light in a second wavelength band so as to promote the second reaction, and emit the light.

In the configuration of an aspect of the present invention, the additive may absorb the light in the first wavelength band so as to generate heat.

In the configuration of an aspect of the present invention, the additive may absorb the light in the first wavelength band and transfer the energy of the absorbed light in the first wavelength band on the basis of the Foerster mechanism between the additive and the photosensitive polymer.

In the configuration of an aspect of the present invention, the additive may absorb light, as the light in the first wavelength band, that causes the first reaction and provide the energy to the photosensitive polymer.

In the configuration of an aspect of the present invention, the additive may absorb light, as the light in the first wavelength band, in a wavelength band different from the wavelength band of the light that causes the first reaction and provide the energy to the photosensitive polymer.

In the configuration of an aspect of the present invention, the photosensitive polymer may undergo a photoisomerization reaction as the first reaction.

In the configuration of an aspect of the present invention, the photosensitive polymer may undergo a photodecomposition reaction as the first reaction.

An aspect of the present invention provides a liquid crystal panel including a pair of substrates, a liquid crystal layer interposed between the pair of substrates, and an alignment film disposed on a liquid-crystal-layer-side surface of each of the pair of substrates, wherein at least one of the alignment films included in the pair of substrates is formed of the above-described composition.

In the configuration of an aspect of the present invention, the alignment film formed of the composition may include a portion in which the concentration of the additive increases from the surface of the alignment film in the thickness direction of the alignment film.

An aspect of the present invention provides a liquid crystal display device including the above-described liquid crystal panel.

An aspect of the present invention provides an electronic device including the above-described liquid crystal panel.

### Advantageous Effects of Invention

According to some aspects of the present invention, a composition capable of readily forming an alignment film that has a high alignment regulation force can be provided. Also, a high-performance liquid crystal panel including an alignment film formed of such a composition can be provided. Also, a liquid crystal display device or an electronic device that includes such a liquid crystal panel can be provided.

### BRIEF DESCRIPTION OF DRAWINGS

FIG. 1 is a schematic diagram illustrating an isomerization reaction of first polymer.

FIG. 2A is a step diagram showing a method for manufacturing an alignment film formed by using a composition according to a first embodiment.

FIG. 2B is a step diagram showing the method for manufacturing an alignment film formed by using the composition according to the first embodiment.

FIG. 2C is a step diagram showing the method for manufacturing an alignment film formed by using the composition according to the first embodiment.

FIG. 3 is a schematic plan view showing the manner when a coating film is irradiated with polarized light.

FIG. 4A is a step diagram showing a method for manufacturing an alignment film formed by using a composition according to a second embodiment.

FIG. 4B is a step diagram showing the method for manufacturing an alignment film formed by using the composition according to the second embodiment.

FIG. 4C is a step diagram showing the method for manufacturing an alignment film formed by using the composition according to the second embodiment.

FIG. 5 is a schematic plan view showing the manner when an imide film is irradiated with polarized light.

FIG. 6 is a schematic sectional view showing a liquid crystal panel and a liquid crystal display device according to a third embodiment.

FIG. 7 is a schematic sectional view showing a liquid crystal panel and a liquid crystal display device according to a fourth embodiment.

FIG. 8A is a step diagram showing a method for manufacturing the liquid crystal panel according to the fourth embodiment.

FIG. 8B is a step diagram showing the method for manufacturing the liquid crystal panel according to the fourth embodiment.

FIG. 8C is a step diagram showing the method for manufacturing the liquid crystal panel according to the fourth embodiment.

FIG. 8D is a step diagram showing the method for manufacturing the liquid crystal panel according to the fourth embodiment.

FIG. 9 is a schematic diagram showing an electronic device according to a fifth embodiment.

FIG. 10 is a schematic diagram showing an electronic device according to the fifth embodiment.

FIG. 11 is a schematic diagram showing an electronic device according to the fifth embodiment.

### DESCRIPTION OF EMBODIMENTS

### First Embodiment

<Composition>

A composition according to a first embodiment of the present invention contains a photosensitive polymer in which the molecular structure changes due to absorption of light and an additive that absorbs at least ultraviolet rays and that provides the energy of the absorbed ultraviolet rays to the photosensitive polymer.

(Photosensitive Polymer)

The photosensitive polymer used for the composition according to the present embodiment absorbs ultraviolet rays when specifically polarized ultraviolet rays are irradiated so as to undergo a first reaction that generates anisotropy in the molecular alignment of the photosensitive polymer in accordance with the polarization direction of the polarized light and a second reaction that further enhances the anisotropy generated in the molecular alignment of the photosensitive polymer by the first reaction. Explanations will be provided below sequentially.

(First Polymer)

Regarding the composition according to the present embodiment, a polymer including, in the main chain, an azobenzene portion having a structure denoted by formula (1-1) described below is used as the photosensitive polymer. As described later, the photosensitive polymer has only to include the azobenzene portion because the azobenzene portion is a photosensitive part that undergoes a predetermined photoreaction. Examples of such photosensitive polymers include polymers having an azobenzene portion in the main chain, for example, polyamic acids, polyimides, polyamides, polyesters, and polyethers, and polymers having an azobenzene portion in the side chain, for example, polyacrylic acids, polymethacrylic acids, and polyethylenes.

In particular, in consideration of the solubility when a composition solution is irradiated or the flexibility of a polymer when a photochemical reaction advances efficiently, it is preferable that the photosensitive polymer be a polyamic acid including an azobenzene portion having a structure denoted by formula (1-1) described below in the main chain. In the following description, the polyamic acid including an azobenzene portion denoted by formula (1-1) described below may be referred to as a “first polymer”.

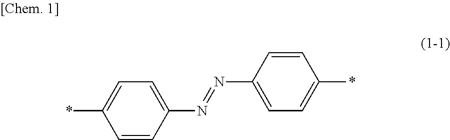 [SMILES: *c1ccc(/N=N/c2ccc(*)cc2)cc1]

Such a polyamic acid is preferably made into a polyamide by subjecting a carboxylic acid and an amine in the polyamic acid to dehydration-condensation after film formation in order to ensure reliability in use as an alignment film of a liquid crystal display device.

Regarding the first polymer, the azobenzene portion denoted by formula (1-1) described above undergoes a photochemical reaction by being irradiated with light having a predetermined wavelength.

In this regard, when the first polymer is irradiated with light (ultraviolet rays) having a wavelength of 350 nm to 370 nm, a photoisomerization reaction occurs, where a trans isomer denoted by formula (1-1) described above is isomerized to a cis isomer denoted by formula (1-2) described below. The present reaction corresponds to the above-described “first reaction”. The present reaction is a reaction “that generates anisotropy in the molecular alignment of a photosensitive polymer”, as described later in detail.

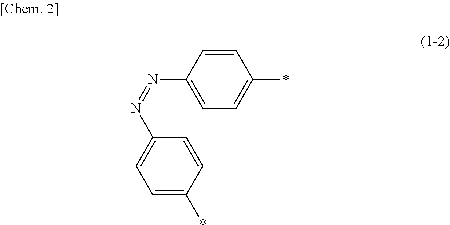 [SMILES: *c1ccc(/N=N\c2ccc(*)cc2)cc1]

Meanwhile, when a polyamic acid having a structure denoted by formula (1-2) described above in the main chain is irradiated with visible light having a wavelength of 400 nm to 520 nm, preferably light having a wavelength of 450 nm to 480 nm, the cis isomer denoted by formula (1-2) described above is isomerized to the trans isomer denoted by formula (1-1) described above. Alternatively, when a polyamic acid having a structure denoted by formula (1-2) described above in the main chain is heated, the cis isomer is also isomerized to the trans isomer. The present reaction corresponds to the above-described “second reaction”. The present reaction is a reaction “that further enhances the anisotropy generated in the molecular alignment of the photosensitive polymer by the first reaction”, as described later in detail.

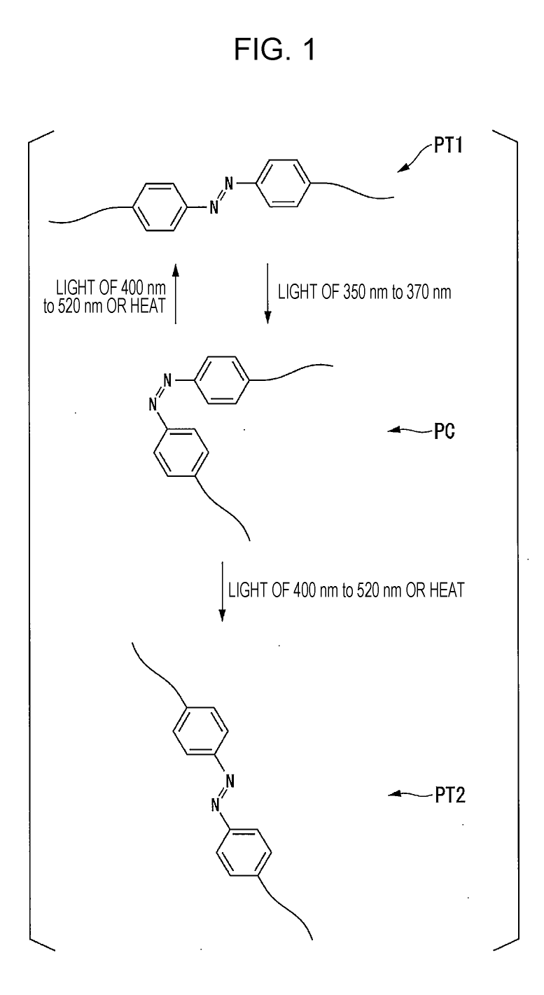

FIG. 1 is a schematic diagram illustrating the above-described isomerization reaction. As shown in FIG. 1, when the trans isomer of the first polymer (indicated by reference numeral PT1 in the drawing) is irradiated with ultraviolet rays having a wavelength of 350 nm to 370 nm, the azobenzene portion undergoes a photoisomerization reaction, and the cis isomer of the first polymer (indicated by reference numeral PC in the drawing) is generated. Subsequently, when the cis isomer PC is irradiated with light having a wavelength of 400 nm to 520 nm, a reaction in which the cis isomer returns to the trans isomer of the first polymer occurs.

At that time, two postures may result in accordance with the position of an end portion that moves centering the azobenzene portion. The resulting structure may be returned to the original structure in which the arrangement is indicated by the trans isomer PT1, or the resulting structure may have an arrangement indicated by a trans isomer PT2 in which alignment has been performed in a direction intersecting the main chain of the original trans isomer PT1.

Meanwhile, when dehydration-condensation occurs in the molecule of such a first polymer, a polyamic acid is converted to a polyimide so as to produce a stable alignment film.

(Additive)

Examples of additives used for the composition according to the present invention include the following three types of additives.

(1) A compound that absorbs light in a first wavelength band, that converts the absorbed light in the first wavelength band to light in a second wavelength band so as to promote the second reaction, and that emits the light (first additive)
(2) A compound that absorbs light in the first wavelength band so as to generate heat (second additive)
(3) A compound that absorbs the light in the first wavelength band and that transfers the energy of the absorbed light in the first wavelength band on the basis of the Foerster mechanism between the additive and the photosensitive polymer (third additive)

Each of these additives is a compound that absorbs light in the first wavelength band, the light causing the first reaction, (hereafter also referred to as “main light”) and that provides energy to the photosensitive polymer. Regarding the first polymer, the main light is preferably 350 nm to 370 nm that is an absorption band of π-π* transition of an azobenzene trans isomer. In this regard, the absorption band of π-π* transition of the main light may shift under the influence of a substituent around the azobenzene portion. In this case, the absorption band of the main light may be 340 nm to 380 nm.

When the absorption band of the additive is the above-described wavelengths, a predetermined reaction can be caused without depending on degradation of a light source used during exposure and a variation in a radiation spectrum with time.

That is, a radiation spectrum of a light source (radiation intensity ratio at each wavelength) varies in accordance with the type of the light source and degradation with time. However, predetermined energy can be reliably obtained because the additive absorbs the main light and converts the main light to the energy for causing the second reaction.

In addition, the main light contained in ultraviolet rays irradiated to the composition is converted to the energy for causing the second reaction in the proportion in accordance with the amount of the additive. Consequently, the second reaction occurs in accordance with the amount of the main light regardless of the type of the light source and the state of variation with time.

As a result, stable cell characteristics are obtained regardless of the type of the light source and the state of variation with time. In this case, it is more preferable that only the main light be irradiated through a band path filter during exposure.

Meanwhile, each of these additives may be a compound that absorbs light, as the light in the first wavelength band, in a wavelength band different from the wavelength band of the main light and that provides energy to the photosensitive polymer.

In this case, the additive does not absorb the main light and, therefore, the additive does not hinder the first reaction. In addition, even when the intensity of the main light of the light source used is low, the second reaction can be caused effectively by using light in the other wavelength band.

“Light in a wavelength band different from the wavelength band of the main light” depends on the type of the light source. When a high-pressure mercury lamp is used as the light source of exposure of the composition, ranges of peak wavelengths, 229 nm, 265 nm, 299 nm, 304 nm, 313 nm, 334 nm, 405 nm, and 436 nm, ±2.5 nm are adopted.

Regarding the additive, for example, when a liquid crystal panel including the alignment film formed of the composition according to an aspect of the present invention is used in combination with a backlight, it is preferable that the absorption wavelength band of the additive do not overlap the wavelength band of the light emitted from the backlight. Specifically, in the absorption spectrum of the additive, it is preferable that the main absorption peak be not included in a visible light region (400 nm to 800 nm). In addition, regarding the absorption spectrum of the additive, it is preferable that the main absorption peak be not included in the wavelength region (440 nm to 700 nm) of three primary colors, red (R), green (G), and blue (B).

Meanwhile, it is preferable that the additive has no light-scattering property. Consequently, preferably, the additive is dispersed into the composition and is dispersible into an alignment film when the alignment film is disposed.

(First Additive)

The first additive is a compound that absorbs light in the first wavelength band, that converts the absorbed light in the first wavelength band to light in the second wavelength band so as to promote the second reaction, and that emits the light. When the composition according to the present embodiment contains the first additive and the composition is irradiated with ultraviolet rays, the first polymer undergoes the first reaction and, in addition, the first additive emits light in the second wavelength band. When the first additive emits light, the first polymer absorbs the generated light, and the first polymer undergoes the second reaction effectively.

It is preferable that the first additive can convert the absorbed light to light in the second wavelength band of 400 nm to 520 nm, in particular, 450 nm to 480 nm that is the absorption band of n-π* transition of azobenzene cis isomer.

Examples of the first additive include organic fluorophores and inorganic nanoparticle fluorophores. In particular, when the additive is an organic fluorophore, the emission spectrum is broad. Therefore, the wavelength band in which the second reaction occurs can be covered broadly and, the second reaction can be caused favorably and effectively.

Specific examples of the first additive include 6,8-difluoro-7-hydroxy-4-methylcoumarin (formula (1-a) described below, absorption wavelength of 358 nm, and emission wavelength of 450 nm),

4′,6-diamidino-2-phenylindole (formula (1-b) described below, absorption wavelength of 353 nm, and emission wavelength of 465 nm),

CellTracker Blue (absorption wavelength of 362 nm and emission wavelength of 463 nm),

Coumarin 30 (formula (1-c) described below, absorption wavelength of 406 nm, and emission wavelength of 478 nm),

Coumarin 314 (formula (1-d) described below, absorption wavelength of 436 nm, and emission wavelength of 476 nm),

Coumarin 334 (formula (1-e) described below, absorption wavelength of 445 nm, and emission wavelength of 475 nm),

Perylene (formula (1-f) described below, absorption wavelengths of 389, 411, and 438 nm, and emission wavelengths of 450 and 476 nm), and

9,10-Bis(Phenylethynyl)Anthracene (formula (1-g) described below, absorption wavelengths of 271, 310, and 434 nm, and emission wavelengths of 467 and 498 nm).

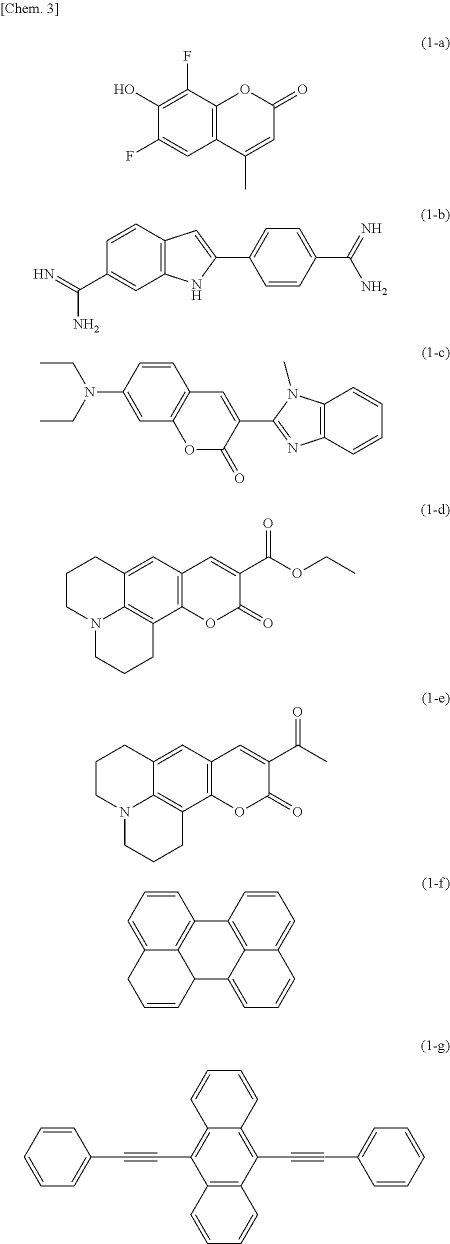

The above-described compounds are examples of luminophores, and at least one hydrogen atom in each luminophore may be substituted with a hydrocarbon group or a halogen atom. Regarding a hydrocarbon group that substitutes for a hydrogen atom in the above-described luminophore, at least one hydrogen atom in the hydrocarbon group may be substituted with a halogen atom, and at least one carbon atom may be substituted with a heteroatom. Meanwhile, elements constituting the first additive may include an isotope of carbon, hydrogen, nitrogen, or the like.

(Second Additive)

The second additive is a compound that absorbs light in the first wavelength band so as to generate heat. When the composition according to the present embodiment contains the second additive and the composition is irradiated with ultraviolet rays, the first polymer undergoes the first reaction and, in addition, the second additive generates heat. When the second additive generates heat, the resulting heat is provided to the first polymer, and the first polymer undergoes the second reaction effectively.

Regarding the second additive, preferably, the type and the amount of the second additive are controlled such that when the composition is irradiated with ultraviolet rays, the composition is heated to a temperature of about 40° C. to 300° C. The isomerization reaction from the cis isomer to the trans isomer, that is, the second reaction, of the azobenzene portion of the first polymer contained in the composition is promote by heating to 40° C. or higher. Meanwhile, when a common high-molecular-weight material is heated to higher than 300° C., a side reaction, e.g., thermal decomposition, phase transition, or fusing occurs. Therefore, preferably, the type and the amount of the second additive are controlled such that when the composition is irradiated with ultraviolet rays, the temperature of the composition is controlled to be 300° C. or lower.

In particular, when the main chain of the first polymer is a polyamic acid and the composition including the second additive is irradiated with ultraviolet rays, the temperature of the composition becomes preferably 100° C. to 150° C. In this regard, the type and the amount of the second additive are controlled such that the composition is heated to a temperature in the above-described appropriate temperature range during ultraviolet ray irradiation and, thereby, the first polymer can undergo the second reaction effectively and, in addition, a side reaction can be suppressed.

Meanwhile, when the main chain of the first polymer is a polyamic acid in which a structural unit having an alkylene bond is included in the main chain, if heating is performed to 100° C. or higher, thermal motion of a polymer chain in the alignment film is activated, and an isomerization reaction from the trans isomer to the cis isomer, that is, the first reaction, tends to advance. On the other hand, if the first polymer is heated to a temperature of higher than 150° C., imidization tends to advance, the polymer main chain becomes rigid, and thermal motion tends to be constrained. Therefore, preferably, the type and the amount of the second additive are controlled such that when the composition is irradiated with ultraviolet rays, the composition is heated to a temperature of about 40° C. to 150° C. In this regard, examples of the polyamic acid in which the main chain includes a structural unit having an alkylene bond include polymers described in Japanese Patent No. 5671797.

Examples of the second additive includes compounds that absorb ultraviolet rays and that generate heat due to molecular vibration or a rotational motion of molecule (molecular-vibration-type compounds). Preferably, such a compound has a molar absorption coefficient of 20,000 l/(mol·cm) or more in a wavelength region of ultraviolet rays.

Specific examples of such a second additive include benzotriazole-based ultraviolet absorbers denoted by formulae (1), (m), and (n) described below and a triazine-based ultraviolet absorber denoted by formula (o) described below.

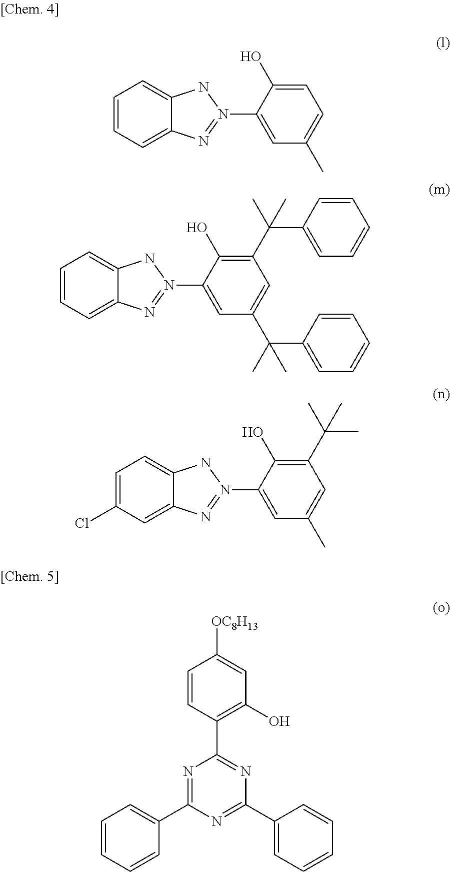

Alternatively, examples of the second additive include compounds that absorb ultraviolet rays so as to undergo isomerization and that generate heat when a structural isomer returns to the original structure (structure-change-type compounds). Specific examples of such a second additive include norbornadiene, as shown in formula (p) described below, and derivatives thereof and metal complexes including fulvalene, as shown in formula (q), described below.

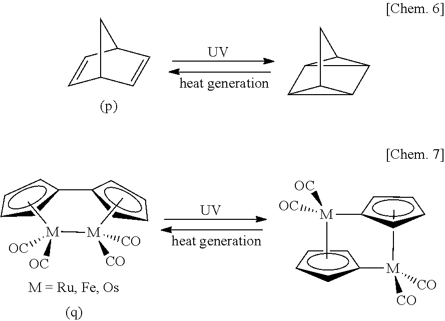

(Third Additive)

The third additive is a compound that absorbs the light in the first wavelength band and that transfers the energy of the absorbed light in the first wavelength band on the basis of the Foerster mechanism between the additive and the photosensitive polymer. When the composition according to the present embodiment contains the third additive and the composition is irradiated with ultraviolet rays, the first polymer undergoes the first reaction and, in addition, the third additive transfers energy to the first polymer. The first polymer undergoes the second reaction effectively due to the energy obtained from the third additive.

Examples of the third additive include compounds that have a lower energy level in an excited state than the energy level in the excited state when the first polymer undergoes the second reaction. The energy levels of the third additive and the first polymer can be calculated by using, for example, a density functional method in Gaussian09.

The composition according to an embodiment of the present invention may include other components, e.g., a polyamic acid having no optical alignment property, a derivative of a polyamic acid having no optical alignment property, an organic silicone compound, a cross-linking agent, and a solvent, within the bounds of not impairing the effects according to the embodiment of the present invention.

(Method for Manufacturing Alignment Film)

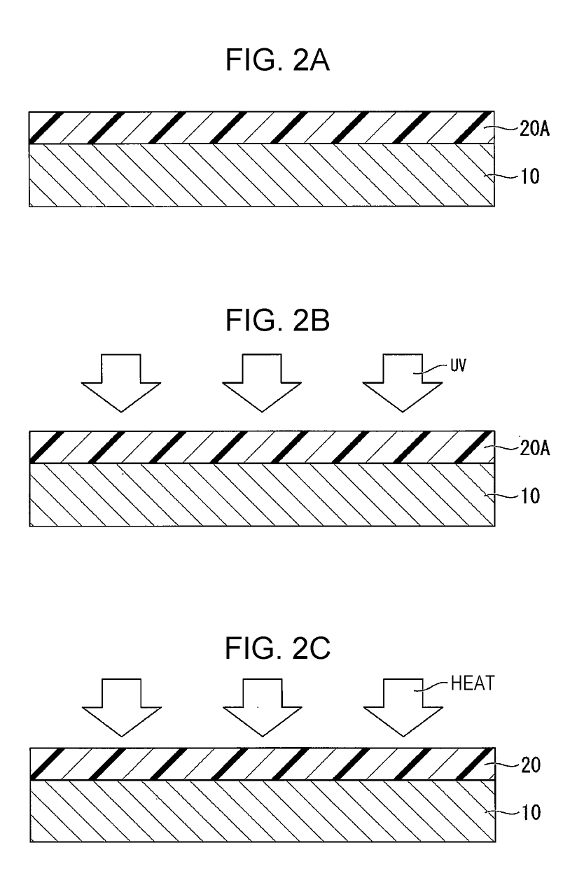

FIGS. 2A to 2C are step diagrams showing a method for manufacturing an alignment film formed by using the composition according to the present embodiment. Initially, as shown in FIG. 2A, a coating film 20A is formed by spin-coating the surface of a substrate 10 with a solution (varnish) in which the composition according to the present embodiment is dissolved into an organic solvent and performing, for example, prebaking at 70° C. for 3 minutes.

Examples of the organic solvent for dissolving the composition include a 3:1 mixed solvent of N-methyl-2-pyrrolidone (NMP) and butyl cellosolve. Meanwhile, 6,8-difluoro-7-hydroxy-4-methylcoumarin (formula (1-a) described above) that has a main absorption band at a wavelength in the vicinity of 358 nm and that emits light with a wavelength of 405 nm is used as the additive contained in the composition.

Subsequently, as shown in FIG. 2B, the coating film 20A is irradiated with ultraviolet rays including polarized light (hereafter referred to as “polarized ultraviolet rays”). The irradiated polarized ultraviolet rays have a peak of radiation spectrum at 365 nm.

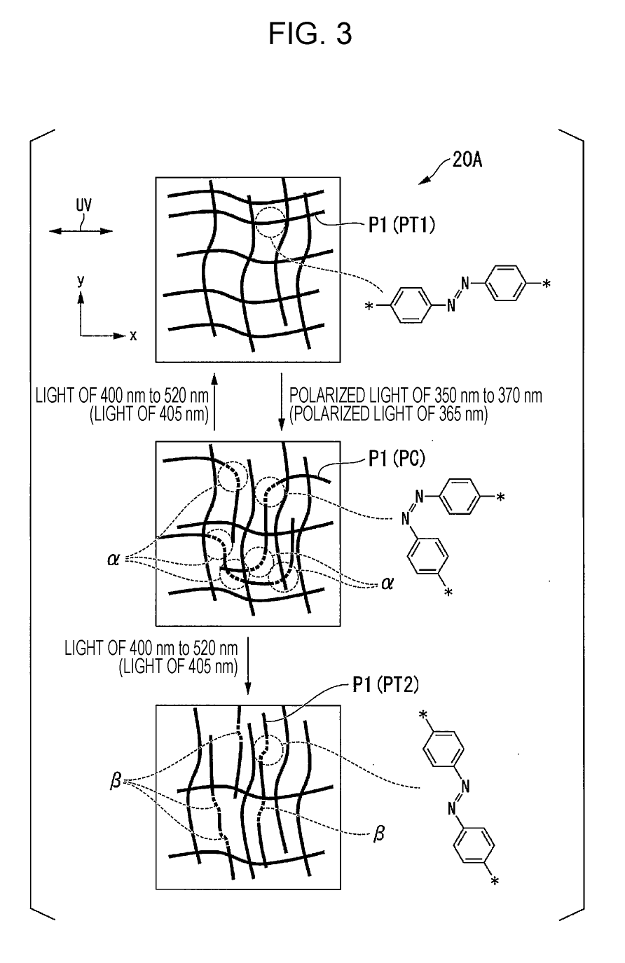

Here, a reaction that occurs in the coating film 20A when the coating film 20A is irradiated with polarized ultraviolet rays, as shown in FIG. 2B, will be described in detail. FIG. 3 is a schematic plan view showing the manner when the coating film 20A is irradiated with the polarized light.

In FIG. 3, an xy coordinate system is adopted for the sake of convenience. In addition, the polarization axis of the polarized ultraviolet rays irradiated to the coating film 20A is assumed to be the x-axis direction. Further, it is shown that a first polymer P1 contained in the coating film 20A extends in the x-axis direction or the y-axis direction in a substantially uniform proportion. The first polymer contained in the coating film 20A is the trans isomer PT1 shown in FIG. 1.

When such a coating film 20A is irradiated with polarized ultraviolet rays with a wavelength of 350 nm to 370 nm (polarized ultraviolet rays having a peak of radiation spectrum at 365 nm), the first polymer P1 that extends in the y-axis direction does not absorb the polarized ultraviolet rays. On the other hand, the first polymer P1 that extends in the x-axis direction absorbs at least some of the polarized ultraviolet rays. At that time, the first polymer P1 undergoes the first reaction in which the azobenzene portion is isomerized from trans to cis, and a cis isomer PC results. Such a reaction simultaneously occurs at a plurality of places (indicated by reference numeral α, in the drawing).

Consequently, among the first polymers P1 contained in the coating film 20A, polymers having postures that can absorb polarized ultraviolet rays are bended, and some of the main chains of the first polymers P1 extend in the y-axis direction. As a result, the molecular alignment of the first polymers P1 becomes one-sided in the y-axis direction so as to generate anisotropy. That is, the first reaction generates the anisotropy in the molecular alignment of the photosensitive polymer (first polymer).

Further, the composition constituting the coating film 20A contains 6,8-difluoro-7-hydroxy-4-methylcoumarin as the additive (first additive) that has a main absorption band at a wavelength in the vicinity of 358 nm and that emits light with a wavelength of 405 nm. Consequently, the light that is the irradiated polarized ultraviolet rays and that is not absorbed by the first polymer P1 is absorbed by the first additive and is converted to the light with a wavelength of 405 nm.

The light with a wavelength of 405 nm is further absorbed by the cis isomer PC of the first polymer. The cis isomer PC undergoes the second reaction in which the azobenzene portion is isomerized from cis to trans. At this time, regarding molecular chains that extend in both-side directions centering the azobenzene portion, when the molecular chain that moved in the first reaction moves again, the first polymer returns to the original trans isomer PT1. On the other hand, when a molecular chain opposite to the molecular chain that moved in the first reaction moves, the first polymer results in the trans isomer PT2 that extends in the y-axis direction. That is, the second reaction enhances the anisotropy caused in the molecular alignment of the photosensitive polymer (second polymer) in the first reaction. Such a reaction simultaneously occurs at a plurality of places (indicated by reference numeral β, in the drawing).

In this regard, the probability of occurrence of the trans isomer PT1 and the probability of occurrence of the trans isomer PT2 by the second reaction are equal. However, the trans isomer PT1 that extends in the x-axis direction absorbs polarized ultraviolet rays again so as to result in the cis isomer PC, whereas the trans isomer PT2 does not absorb polarized ultraviolet rays having a polarization axis in the x-axis direction and, therefore, is not isomerized to the cis isomer PC. Consequently, when ultraviolet irradiation continues, the amount of the trans isomer PT2 present increases gradually, and the alignment regulation force of the resulting alignment film in the y-axis direction is enhanced.

Thereafter, as shown in FIG. 2C, the polyamic acid of the first polymer P1 is imidized by, for example, performing heating at 230° C. for 40 minutes so as to produce an alignment film 20.

In this manner, an alignment film can be formed of the composition according to the present embodiment.

Meanwhile, when the additive contained in the composition is the second additive, the reaction advances in the same manner as in the case in which the above-described first additive is contained except that the second reaction in which the trans isomer PT2 is produced from the cis isomer PC occurs due to the heat generated by the second additive.

Meanwhile, when the additive contained in the composition is the third additive, the reaction advances in the same manner as in the case in which the above-described first additive is contained except that the second reaction in which the trans isomer PT2 is produced from the cis isomer PC occurs due to the energy transferred from the third additive to the first polymer on the basis of the Foerster mechanism.

Regarding the composition having the above-described configuration, a composition capable of readily forming an alignment film that has a high alignment regulation force can be provided.

In this regard, in the present embodiment, only polarized ultraviolet irradiation is performed. However, when the absorption wavelength band of the additive is different from the absorption wavelength band of the photosensitive polymer, the light in accordance with each of the absorption wavelengths may be irradiated. The polarized ultraviolet rays that is the light to be irradiated to the photosensitive polymer and the light to be irradiated to the additive may be irradiated simultaneously or be irradiated alternately, for example.

### Second Embodiment

(Second Polymer)

Regarding the composition according to the present embodiment, a polyimide including a cyclobutane diimide portion having a structure denoted by formula (2-1) described below in the main chain is used as the photosensitive polymer. In the following description, the polyimide including the cyclobutane diimide portion denoted by formula (2-1) may be referred to as a “second polymer”.

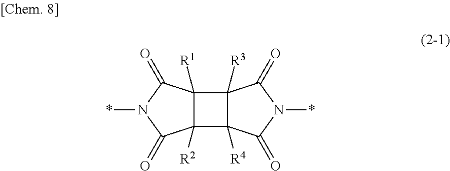

In this regard, each of R¹ to R⁴ in formula (2-1) described above represents a hydrogen atom or an alkyl group having a carbon number of 1 to 4. In order to improve the efficiency of the photochemical reaction, it is preferable that R¹ and R³ or R¹ and R⁴ be alkyl groups having a carbon number of 1 or 2, that is, a methyl group or an ethyl group.

Regarding the second polymer, the structure denoted by formula (2-1) described above undergoes a photochemical reaction by being irradiated with light having a predetermined wavelength.

Regarding the second polymer, the cyclobutane diimide portion denoted by formula (2-1) described above undergoes a photochemical reaction by being irradiated with light having a predetermined wavelength.

In this regard, when the second polymer is irradiated with light (ultraviolet rays) having a wavelength of 240 nm to 260 nm that is an absorption band of π-π* transition of an aromatic ring in the vicinity of an imide group, electrons of the aromatic ring irradiated with the ultraviolet rays are excited. The energy of excited electrons is transferred from the aromatic ring to the cyclobutane diimide portion so as to cause a photodecomposition reaction in which a cyclobutane ring of the cyclobutane diimide portion denoted by formula (2-1) described above is opened and, thereby, maleimide denoted by formula (2-2) described below results and the molecular weight is reduced.

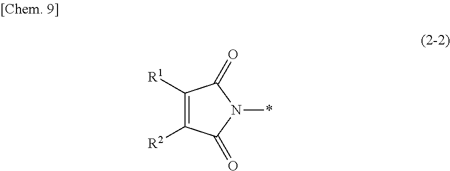

In this regard, maleimide including R¹ and R² denoted by formula (2-2) is described as a fragment generated as a result of the photodecomposition reaction. However, maleimide including R³ and R⁴ is generated simultaneously, as a matter of course.

Here, examples of the above-described “aromatic ring in the vicinity of an imide group” include a phenylene group directly bonded to nitrogen of the imide group and a phenylene group bonded to nitrogen of the imide group with an alkylene group having a carbon number of 1 to 4 interposed therebetween. As described above, the aromatic ring in the vicinity of an imide group adsorbs ultraviolet rays, and a photodecomposition reaction is caused by the absorbed energy being transferred from the aromatic ring to the cyclobutane diimide portion. Therefore, the aromatic ring is preferably located at a position close to an imide group and is preferably directly bonded to nitrogen.

The present reaction corresponds to the above-described “first reaction”. The present reaction is a reaction “that generates anisotropy in the molecular alignment of the photosensitive polymer”, as described later in detail.

Meanwhile, when a polyamic acid having a structure denoted by formula (2-2) described above in the main chain is irradiated with light having a wavelength of 280 nm to 400 nm and preferably light having a wavelength of 300 nm to 330 nm, the maleimide portion denoted by formula (2-2) described above is dimerized to the cyclobutane diimide portion denoted by formula (2-1) described above. Alternatively, the maleimide portion denoted by formula (2-2) described above is polymerized so as to generate a polymer having a structure denoted by formula (2-3) described below.

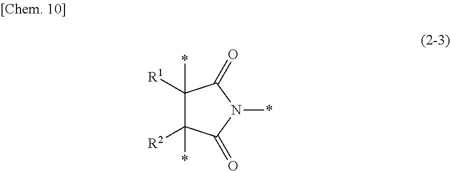

In this regard, the polymer in which maleimide including R¹ and R² is polymerized is denoted by formula (2-3). However, maleimide including R³ and R⁴ may also be polymerized so as to generate a polymer, as a matter of course.

The present reaction corresponds to the above-described “second reaction”. The present reaction is a reaction “that enhances the anisotropy generated in the molecular alignment of the photosensitive polymer by the first reaction”, as described later in detail.

(Additive)

Regarding the additive to be used for the composition according to the present embodiment, a first additive, a second additive, and a third additive suitable for the above-described reaction of the second polymer may be used under the same concept as that in the first embodiment.

Each of these additives is a compound that absorbs light in the first wavelength band, the light causing the first reaction of the second polymer (main light), and that provides energy to the photosensitive polymer. Regarding the first polymer, the main light is preferably 240 nm to 260 nm that is an absorption band of π-π* transition of the aromatic ring in the vicinity of an imide group of the cyclobutane diimide portion.

(First Additive)

It is preferable that the first additive used for the composition according to the present embodiment can convert the absorbed light to light in the second wavelength band of 280 nm to 400 nm, in particular, 300 nm to 330 nm that is the absorption band of π-π* transition of maleimide.

Specific examples of the first additive include

biphenyl (formula (2-a) described below, absorption wavelength of 247 nm, and emission wavelengths of 303, 313, and 326 nm),

benzene (absorption wavelength of 255 nm and emission wavelength of 303 nm),

2-methylbenzoxazole (formula (2-b) described below, absorption wavelengths of 231, 270, and 277 nm, and emission wavelengths of 300 and 322 nm),

toluene (absorption wavelength of 262 nm and emission wavelength of 303 nm),

naphthalene (absorption wavelengths of 266, 275, and 286 nm and emission wavelength of 322 nm),

ethyl-p-dimethylaminobenzoate (formula (2-c) described below, absorption wavelength of 309 nm, and emission wavelength of 330 nm),

1,4-diphenylbutadiyne (formula (2-d) described below, absorption wavelengths of 305 and 326 nm, and emission wavelength of 330 nm),

9,10-diphenylanthracene (formula (2-e) described below, absorption wavelengths of 279, 288, and 296 nm, and emission wavelengths of 302, 320, and 330 nm), and

p-terphenyl (formula (2-f) described below, absorption wavelength of 276 nm and emission wavelength of 323 nm).

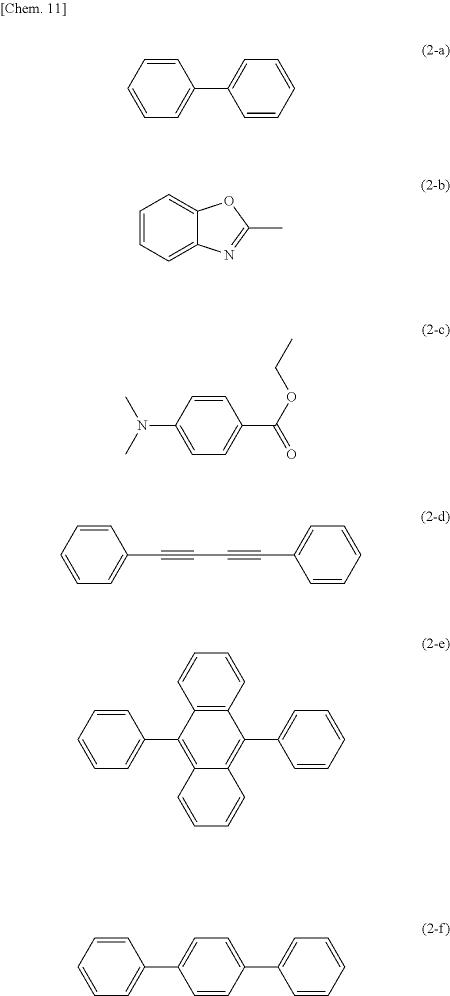

The above-described compounds are examples of luminophores, and at least one hydrogen atom in each luminophore may be substituted with a hydrocarbon group or a halogen atom. Regarding a hydrocarbon group that substitutes for a hydrogen atom in the above-described luminophore, at least one hydrogen atom in the hydrocarbon group may be substituted with a halogen atom, and at least one carbon atom may be substituted with a heteroatom. Meanwhile, elements constituting the first additive may include an isotope of carbon, hydrogen, nitrogen, or the like.

(Second Additive)

The second additive used for the composition according to the present embodiment may be the same as the second additive shown in the first embodiment.

(Third Additive)

Examples of the third additive used for the composition according to the present embodiment include compounds that have an energy level in an excited state lower than the energy level in the excited state when the second polymer undergoes the second reaction. The energy levels of the third additive and the second polymer can be calculated by using, for example, a density functional method in Gaussian09.

The composition according to an embodiment of the present invention may include other components, e.g., a polyamic acid having no optical alignment property, a derivative of a polyamic acid having no optical alignment property, an organic silicone compound, a cross-linking agent, and a solvent, within the bounds of not impairing the effects according to the embodiment of the present invention.

(Method for Manufacturing Alignment Film)

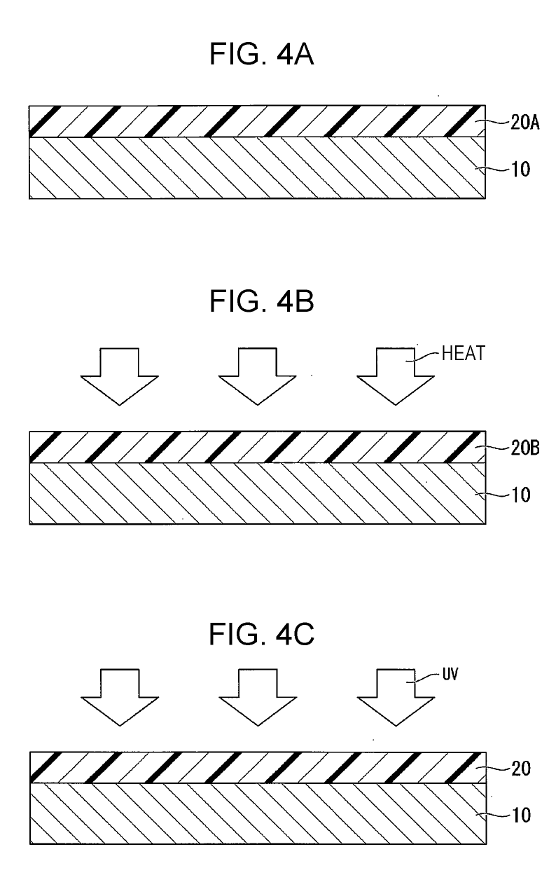

FIGS. 4A to 4C are step diagrams showing a method for manufacturing an alignment film formed by using the composition according to the present embodiment. Initially, as shown in FIG. 4A, the surface of a substrate 10 is spin-coated with a solution (varnish) in which the composition according to the present embodiment is dissolved into an organic solvent. At this time, when the solubility of a polyimide including the cyclobutane diimide portion is low and it is difficult to prepare a solution (varnish) of the composition, a polyamic acid including a cyclobutane portion that is a precursor of the cyclobutane diimide portion is used. Subsequently, a coating film 20A is formed by performing, for example, prebaking at 70° C. for 3 minutes.

Regarding the additive contained in the composition, 1,4-diphenylbutadiyne (formula (2-d) described above) that has a main absorption band at a wavelength in the vicinity of 305 nm and that emits light with a wavelength of 330 nm is used.

Subsequently, as shown in FIG. 4B, when the polyamic acid including a cyclobutane portion is used, the polyamic acid is imidized by, for example, performing heating at 230° C. for 40 minutes so as to produce a polyimide film 20B including the cyclobutane portion of the second polymer P2.

Thereafter, as shown in FIG. 4C, for example, an extra-high-pressure mercury lamp is used as a light source, and the imide film 20B is irradiated with ultraviolet rays including polarized light (hereafter referred to as “polarized ultraviolet rays”). The irradiated polarized ultraviolet rays have a radiation peak at 254 nm. In this regard, the irradiation intensity of the extra-high-pressure mercury lamp at a wavelength of 305 nm is five times higher than the irradiation intensity at a wavelength of 254 nm.

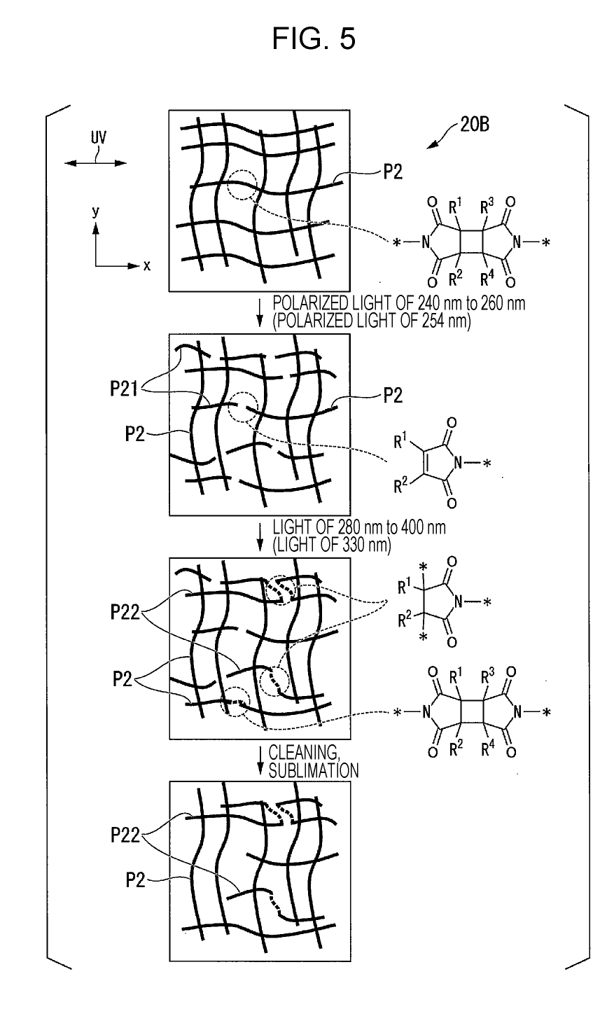

Here, a reaction that occurs in the imide film 20B when the imide film 20B is irradiated with polarized ultraviolet rays, as shown in FIG. 4C, will be described in detail. FIG. 5 is a schematic plan view showing the manner when the imide film 20B is irradiated with the polarized ultraviolet rays.

In FIG. 5, an xy coordinate system is adopted for the sake of convenience. In addition, the polarization axis of the polarized ultraviolet rays irradiated to the imide film 20B is assumed to be the x-axis direction. Further, it is shown that a second polymer P2 contained in the imide film 20B extends in the x-axis direction or the y-axis direction in a substantially uniform proportion.

When such a imide film 20B is irradiated with polarized ultraviolet rays with a wavelength of 240 nm to 260 nm (polarized ultraviolet rays having a radiation peak at 254 nm), the second polymer P2 that extends in the y-axis direction does not absorb the polarized ultraviolet rays. On the other hand, the second polymer P2 that extends in the x-axis direction absorbs at least some of the polarized ultraviolet rays. At that time, the second polymer P2 undergoes the first reaction in which a cyclobutane ring of the cyclobutane diimide portion is opened, and a second polymer having a reduced molecular weight (low-molecular-weight body P21) is generated. Such a reaction simultaneously occurs at a plurality of places. The low-molecular-weight body P21 includes a maleimide portion at an end portion.

As a result of the above-described reaction, the second polymer that extends in the y-axis direction has a higher molecular weight than the second polymer that extends in the x-axis direction so as to generate anisotropy in the molecular alignment. Regarding the alignment film, the alignment regulation force is enhanced as the molecular weight of a resin constituting the alignment film increases. Therefore, the alignment regulation force in the y-axis direction is larger than that in the x-axis direction. That is, the first reaction generates the anisotropy in the molecular alignment of the photosensitive polymer (second polymer).

Further, the composition constituting the imide film 20B contains 1,4-diphenylbutadiyne as the additive (first additive) that has a main absorption band at a wavelength in the vicinity of 305 nm and that emits light with a wavelength of 330 nm. Consequently, the light of 305 nm in the irradiated polarized ultraviolet rays is absorbed by the first additive and is converted to the light with a wavelength of 330 nm.

The light with a wavelength of 330 nm is absorbed by the maleimide portion included in the low-molecular-weight body P21 generated in the first reaction. In the low-molecular-weight body P21, the maleimide portions return to the second polymer P2 by recombination due to dimerization. Alternatively, the second reaction in which the double bond in the maleimide portion undergoes addition polymerization occurs so as to generate a vinyl polymer P22.

At this time, the dimerized and recombined body (second polymer P2) that extends in the x-axis direction by the second reaction absorbs polarized ultraviolet rays again and undergoes the first reaction so as to generate the low-molecular-weight body P21 again. On the other hand, regarding the vinyl polymer P22, the main chain extends in a direction intersecting the main chain of the polymer including maleimide at an end, that is, the y-axis direction, polarized ultraviolet rays are not absorbed and, therefore, no reaction occurs. Consequently, if ultraviolet irradiation continues, the amount of the vinyl polymer P22 present increases gradually, and the alignment regulation force of the resulting alignment film in the y-axis direction is enhanced.

The amount of the low-molecular-weight body P21 derived from the second polymer and generated in the imide film 20B is reduced by such a second reaction.

In general, the alignment film formed of a material that is a photodecomposition type resin material such as the second polymer undergoes decomposition reaction due to ultraviolet irradiation and, thereby, the molecular weight is reduced. If a large amount of low-molecular-weight resin is present in the alignment film, the viscoelasticity of the alignment film is reduced.

Meanwhile, an electric field is applied to a liquid crystal layer, liquid crystal molecules contained in the liquid crystal layer receive a force that causes alignment in the direction of the electric field. At this time, the force applied to the liquid crystal molecules from the electric field is against the alignment regulation force applied from the alignment film, and when the application of the electric field is stopped, the liquid crystal molecules are aligned again in accordance with the alignment regulation force. However, regarding the alignment film having reduced viscoelasticity, as described above, when an electric field is applied to the liquid crystal layer, the alignment film formed of a material that is a photodecomposition type resin material is irreversibly deformed by a force that aligns liquid crystal molecules in the direction of the electric field, and there is a problem in that an “AC afterimage”, in which liquid crystal molecules do not smoothly take original postures when application of the electric field is stopped, readily occurs.

Regarding the above-described problem, in the composition according to the present embodiment, the amount of low-molecular-weight body included in the alignment film after the formation of the alignment film is small compared with the photodecomposition-type resin material that has been previously used as the material for forming an alignment film. As a result, an alignment film that does not easily cause an AC afterimage can be formed.

Meanwhile, the amount of the low-molecular-weight body P21 generated in the imide film 20B is reduced by the above-described second reaction, and elution of the low-molecular-weight body into the liquid crystal layer is significantly suppressed. In general, the solubility of a high-molecular weight material into a solvent depends on the molecular weight, and as the molecular weight decreases, the solubility increases. Therefore, the low-molecular-weight body generated by the photodecomposition reaction is readily eluted into the liquid crystal layer. The low-molecular-weight body eluted into the liquid crystal layer serves as a contaminant of the liquid crystal layer so as to readily cause reduction in resistivity of the liquid crystal layer.

Regarding a liquid crystal panel, when an image is displayed, in general, a driving period in which a voltage is applied to a liquid crystal layer so as to drive and an idle period in which a voltage is cut and driving is performed by a voltage held in the liquid crystal layer are repeated and, thereby, predetermined brightness is maintained. However, when the resistivity of the liquid crystal layer is low, leakage of charge occurs in the liquid crystal layer, and a voltage to be essentially maintained is reduced, that is, a reduction in voltage holding ratio (VHR) occurs.

When the voltage holding ratio is reduced during the idle period, the transmittance of backlight is reduced and, thereby, the brightness of the displayed image is reduced. Consequently, the brightness of the displayed image during the driving period and the brightness during the idle period are different from each other and, thereby, an image quality defect, so called “flickering”, occurs and image flickering is observed.

On the other hand, when the composition according to the present embodiment is made into the alignment film, the amount of the low-molecular-weight body is small, the amount of the low-molecular-weight body eluted into the liquid crystal layer is reduced, and VHR is not readily reduced. As a result, the composition according to the present embodiment can form an alignment film which can reduce occurrences of flickering and which can increase the idle period. The liquid crystal panel including such an alignment film can reduce the number of times of voltage application during the image displaying period and, thereby, the liquid crystal panel features low power consumption.

Further, as the situation demands, a step of removing low-molecular-weight components contained in the imide film 20B may be included. Cleaning or sublimation of low-molecular-weight components may be used for removing the low-molecular-weight components.

As a result of these reactions, the second polymer contained in the coating film in the y-axis direction has a higher molecular weight than that in the x-axis direction, and the alignment regulation force in the y-axis direction is enhanced.

In this manner, an alignment film can be formed of the composition according to the present embodiment.

Meanwhile, when the additive contained in the composition is the second additive, the reaction advances in the same manner as in the case in which the above-described first additive is contained except that the second reaction occurs due to the heat generated by the second additive. In this case, the main reaction of the second reaction is recombination and vinyl polymerization (addition polymerization) reaction of the maleimide portion.

When the low-molecular-weight body of the second polymer is heated to 100° C. or higher by the second additive, the second reaction such as vinyl polymerization of maleimide or dimerization of maleimide readily advances. Further, it is preferable that the second polymer be heated within the range of 150° C. to 250° C. because the anisotropy of the molecular chain alignment of the second polymer in the coating film is readily enhanced. Therefore, regarding the second additive, preferably, the type of the second additive and the amount of addition are controlled such that the composition is heated to a temperature of about 150° C. to 250° C. when the composition is irradiated with ultraviolet rays.

Meanwhile, when the additive contained in the composition is the third additive, the reaction advances in the same manner as in the case in which the above-described first additive is contained except that the second reaction occurs due to the energy transferred from the third additive to the second polymer on the basis of the Foerster mechanism.

Regarding the composition having the above-described configuration, a composition capable of readily forming an alignment film that has a high alignment regulation force can be provided.

In this regard, in the present embodiment, only polarized ultraviolet irradiation is performed. However, when the absorption wavelength band of the additive is different from the absorption wavelength band of the photosensitive polymer, the light in accordance with each of the absorption wavelength may be irradiated. The polarized ultraviolet rays that is the light to be irradiated to the photosensitive polymer and the light to be irradiated to the additive may be irradiated simultaneously or be irradiated alternately, for example.

### Third Embodiment

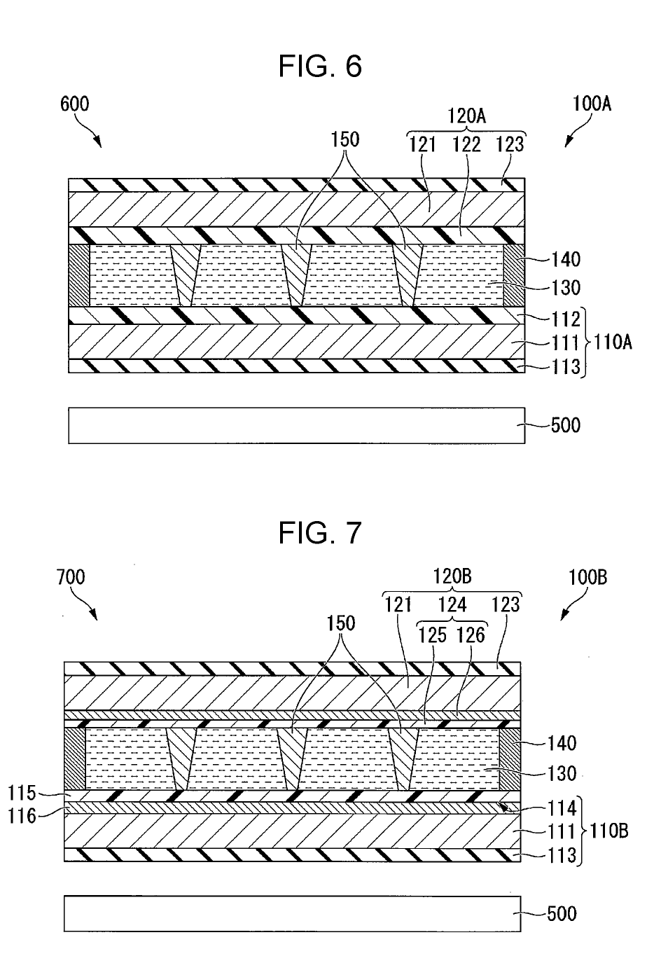

FIG. 6 is a schematic sectional view showing a liquid crystal panel and a liquid crystal display device according to the present embodiment. As shown in FIG. 6, a liquid crystal panel 100A according to the present embodiment includes an element substrate 110A, a counter substrate 120A, a liquid crystal layer 130, a seal portion 140, and spacers 150.

Meanwhile, a liquid crystal display device 600 includes the liquid crystal panel 100A and a backlight 500 disposed on the element substrate 110A side of the liquid crystal panel 100A. In this regard, the liquid crystal display device according to the present embodiment is not limited to a transmissive liquid crystal panel. The liquid crystal display device applicable to the present embodiment may be, for example, a transflective type (transmissive type and reflective type in combination) or a reflective type.

The element substrate 110A includes a TFT substrate 111, an alignment film 112 disposed on one surface of the TFT substrate, and a polarizer 113 disposed on the other surface of the TFT substrate 111. In this regard, the liquid crystal panel applicable to the present embodiment is not limited to an active matrix system in which each pixel is provided with a driving TFT, but the liquid crystal panel may be a passive matrix system in which a driving TFT is not provided on a pixel basis.

The TFT substrate 111 includes a driving TFT element although not shown in the drawing. A drain electrode, a gate electrode, and a source electrode of the driving TFT element is electrically connected to a pixel electrode, gate bus line, and a source bus line, respectively. Pixels are electrically connected to each other via electric wiring of the source bus line and the gate bus line.

Meanwhile, when the liquid crystal panel 100A has a configuration of a horizontal electric field system, e.g., in-plane switching (IPS) or fringe field switching (FFS), in which liquid crystal molecules are horizontally aligned relative to the substrate surface and a horizontal electric field is applied to the liquid crystal layer, the TFT substrate 111 includes a common electrode although not shown in the drawing.

A commonly known material can be used as a material for forming each member of the element substrate 110A. However, it is preferable that IGZO (quaternary mixed crystal semiconductor material containing indium (In), gallium (Ga), Zinc (Zn), and oxygen (O)) be used as the material for forming the semiconductor layer of the driving TFT. When IGZO is used as a material for forming a semiconductor layer, an off-leakage current of the resulting semiconductor layer is small and leakage of charge is suppressed. Consequently, an idle period after a voltage is applied to the liquid crystal layer can be increased. As a result, the number of times of voltage application during the image displaying period can be reduced and, thereby, power consumption of the liquid crystal panel can be reduced.

In particular, when the liquid crystal panel includes an alignment film formed of the composition according to the above-described embodiment, the composition containing the second polymer, leakage of charge in the liquid crystal layer can be suppressed, and the liquid crystal panel can feature more considerably reduced power consumption.

The alignment film 112 is an optical alignment film that is formed by using the above-described composition according to the embodiment of the present invention. The polarizer 113 having a commonly known configuration may be used.

The counter substrate 120A includes a color filter substrate 121, an alignment film 122 disposed on one surface of the color filter substrate 121, and a polarizer 123 disposed on the other surface of the color filter substrate 121.

The color filter substrate 121 includes, for example, a red color filter layer that absorbs part of incident light so as to pass red light, a green color filter layer that absorbs part of incident light so as to pass green light, and a blue color filter layer that absorbs part of incident light so as to pass blue light. The alignment film 122 is an optical alignment film that is formed by using the composition according to the present embodiment of the present invention. The polarizer 123 having a commonly known configuration may be used. The polarizer 113 and the polarizer 123 are in a cross nicols arrangement, for example.

The element substrate 110A and the element substrate 120A hold the liquid crystal layer 130 therebetween while the alignment films 112 and 122 are arranged opposite each other. The liquid crystal layer 130 contains liquid crystal molecules. In the state in which no voltage is applied, the liquid crystal molecules are provided with an alignment property in accordance with the alignment regulation forces of the alignment films 112 and 122.

The seal portion 140 is interposed between the element substrate 110A and the counter substrate 120A and is arranged so as to surround the liquid crystal layer 130.

The spacers 150 are columnar structures disposed so as to regulate the thickness of the liquid crystal layer 130. The spacers 150 are disposed on, for example, the counter substrate 120A side.

The above-described liquid crystal panel may be produced by forming the alignment film 112 on the surface of the TFT substrate 111 and forming the alignment film 122 on the surface of the color filter substrate 121 in accordance with the above-described method for manufacturing the alignment film and, thereafter, by using the resulting element substrate 110A and the counter substrate 120A in accordance with a commonly known method.

In the liquid crystal panel having the above-described configuration, the above-described composition according to the present embodiment of the present invention is used as the material for forming the alignment films 112 and 122 and, therefore, the alignment films 112 and 122 have high alignment regulation forces. Consequently, a high quality liquid crystal panel can be produced.

In addition, the liquid crystal display device having the above-described configuration includes the above-described liquid crystal panel and, therefore, has high performance.

In this regard, in the present embodiment, the material for forming each of the alignment films 112 and 122 is set to be the above-described composition according to the embodiment of the present invention but is not limited to this. When at least one of the materials for forming the alignment films 112 and 122 is the above-described composition according to the embodiment of the present invention, the alignment film formed by using the composition has a high alignment regulation force and, therefore, the effect according to the embodiment of the present invention can be obtained.

### Fourth Embodiment

FIG. 7 is a schematic sectional view showing a liquid crystal panel and a liquid crystal display device according to the present embodiment. As shown in FIG. 7, a liquid crystal panel 100B according to the present embodiment includes an element substrate 110B, a counter substrate 120B, a liquid crystal layer 130, a seal portion 140, and spacers 150. In the present embodiment, the constituent elements common to the third embodiment are indicated by the same reference numerals as those set forth above, and detailed explanations thereof will not be provided.

A liquid crystal display device 700 according to the present embodiment includes the liquid crystal panel 100B and a backlight 500 disposed on the element substrate 110B side of the liquid crystal panel 100B.

The element substrate 110B includes a TFT substrate 111, an alignment film 114 disposed on one surface of the TFT substrate, and a polarizer 113 disposed on the other surface of the TFT substrate 111.

The alignment film 114 is an optical alignment film that is formed by using the above-described composition according to the embodiment of the present invention. The alignment film 114 includes portions in which the concentration of the additive contained in the composition increases from the surface of the alignment film 114 in the thickness direction of the alignment film 114. Specifically, the alignment film 114 includes a low-concentration layer 115 and a high-concentration layer 116 that are different from each other in the concentration of the additive contained in the composition.

The low-concentration layer 115 is disposed on the surface side (liquid crystal layer 130 side) of the alignment film 114. The low-concentration layer 115 is formed by using a material having a relatively lower concentration of the additive contained in the above-described composition according to the embodiment of the present invention than that in the case of the high-concentration layer 116. For example, only the photosensitive polymer contained in the above-described composition according to the embodiment of the present invention may be used as the material for forming the low-concentration layer 115, or a material that contains the additive may be used as long as the concentration of the additive is lower than that in a material for forming the high-concentration layer 116.

The high-concentration layer 116 is disposed opposite to the surface of the alignment film 114 (on the TFT substrate 111 side).

The counter substrate 120B includes a color filter substrate 121, an alignment film 124 disposed on one surface of the color filter substrate 121, and a polarizer 123 disposed on the other surface of the color filter substrate 121.

The alignment film 124 is an optical alignment film that is formed by using the above-described composition according to the embodiment of the present invention. The alignment film 124 includes portions in which the concentration of the additive contained in the composition increases from the surface of the alignment film 124 in the thickness direction of the alignment film 124. Specifically, the alignment film 124 includes a low-concentration layer 125 and a high-concentration layer 126 that are different from each other in the concentration of the additive contained in the composition.

The low-concentration layer 125 is disposed on the surface side (liquid crystal layer 130 side) of the alignment film 124. The low-concentration layer 125 is formed by using a material having a relatively lower concentration of the additive contained in the above-described composition according to the embodiment of the present invention than that in the case of the high-concentration layer 126. For example, only the photosensitive polymer contained in the above-described composition according to the embodiment of the present invention may be used as the material for forming the low-concentration layer 125, or a material that contains the additive may be used as long as the concentration of the additive is lower than that in a material for forming the high-concentration layer 126.

The high-concentration layer 126 is disposed opposite to the surface of the alignment film 124 (on the color filter substrate 121 side).

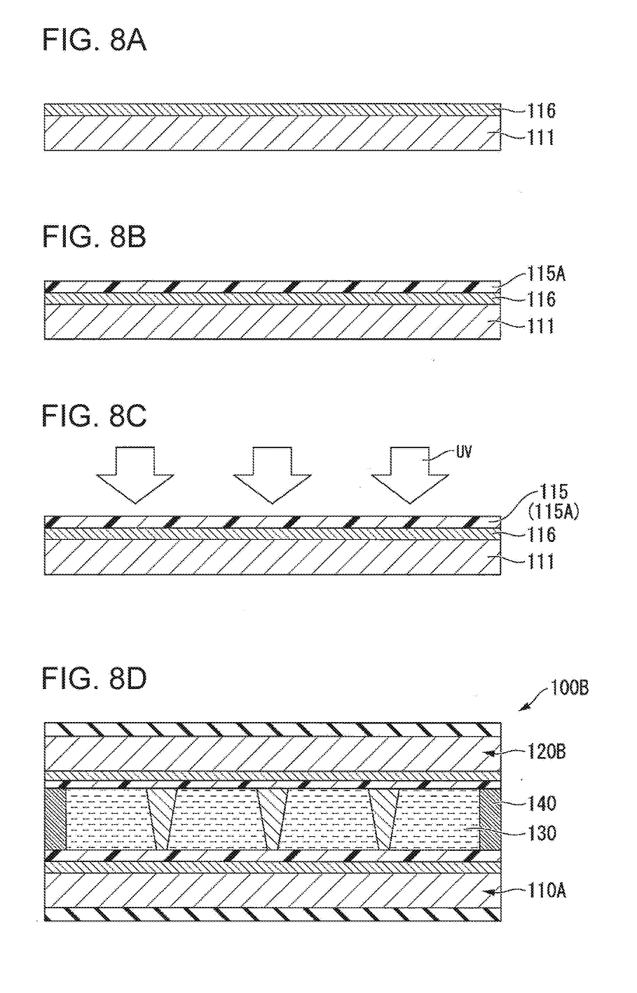

FIGS. 8A to 8D are step diagrams showing a method for manufacturing the liquid crystal panel 100B according to the present embodiment. Here, in the description, it is assumed that the first additive shown in the above-described embodiment is contained as the additive.

Initially, as shown in FIG. 8A, for example, the surface of the TFT substrate 111 is spin-coated with a solution (varnish) in which a non-photosensitive polyamic acid and the above-described first additive are dissolved into an organic solvent. The resulting coating film is, for example, heated at 230° C. for 35 minutes so as to imidize the polyamic acid and produce the high-concentration layer 116.

Examples of the organic solvent for dissolving the non-photosensitive polyamic acid and the above-described first additive include a 3:1 mixed solvent of NMP and butyl cellosolve. Meanwhile, 6,8-difluoro-7-hydroxy-4-methylcoumarin (formula (1-a) described above) is used as the additive contained in the composition in the same manner as in the step diagrams shown in FIGS. 2A to 2C according to the first embodiment.

Subsequently, as shown in FIG. 8B, a coating film 115A is formed by spin-coating the surface of the high-concentration layer 116 with a solution (varnish) in which the first polymer contained in the composition according to the present embodiment is dissolved into an organic solvent and performing, for example, prebaking at 70° C. for 3 minutes.

Thereafter, as shown in FIG. 8C, a multilayer body of the coating film 115A and the high-concentration layer 116 is irradiated with polarized ultraviolet rays. The irradiated polarized ultraviolet rays have a peak of radiation spectrum at 365 nm.

When the coating film 115A is irradiated with polarized ultraviolet rays, the first polymer absorbs the polarized ultraviolet rays and the first reaction occurs. On the other hand, the remainder of the polarized ultraviolet rays is not absorbed by the coating film 115A and reaches the high-concentration layer 116. In the high-concentration layer 116, 6,8-difluoro-7-hydroxy-4-methylcoumarin absorbs the polarized ultraviolet rays, and emits light with a wavelength of 405 nm. In the coating film 115A, the first polymer absorbs the light with a wavelength of 405 nm emitted from the high-concentration layer 116, and the second reaction occurs.

Consequently, when the multilayer body of the coating film 115A and the high-concentration layer 116 is irradiated with polarized ultraviolet rays, the coating film 115A is converted to the low-concentration layer 115 having alignment anisotropy in a direction intersecting the polarization direction. At this time, in the low-concentration layer 115, the first polymer can sufficiently absorb the polarized ultraviolet rays because the content of the first additive is small. Therefore, the first reaction occurs even when the amount of light is small. Meanwhile, the second reaction occurs due to the light emitted from the high-concentration layer 116. As a result, an alignment film having a high alignment regulation force can be produced even when the amount of exposure is small.

Next, as shown in FIG. 8D, a low-concentration layer 125 and a high-concentration layer 126 are formed on the color filter substrate 121 side in the same manner, and assembling is performed in accordance with a common method so as to produce a liquid crystal panel 100B.

In the liquid crystal panel 100B having the above-described configuration, the low-concentration layer 115 is present between the high-concentration layer 116 containing a large amount of additive that constitutes the composition according to the present embodiment and the liquid crystal layer 130. Likewise, the low-concentration layer 125 is present between the high-concentration layer 126 and the liquid crystal layer 130. Consequently, a high-quality liquid crystal panel having a high alignment regulation force is produced. In addition, the liquid crystal layer 130 and the high-concentration layer 116 that contains a high concentration of additive are separated from each other. Therefore, isolation or elution of the additive into the liquid crystal layer 130 do not readily occur, and a liquid crystal panel having good VHR characteristics can be produced.

In this regard, in the present embodiment, the additive contained in the high-concentration layer is set to be the first additive but is not limited to this. The second additive may be used. Among the second additives, an additive, for example, 2-(2-benzotriazolyl)-p-cresol (benzotriazole-based ultraviolet absorber denoted by formula (1) described above) that has a large amount of heat generation due to absorption of ultraviolet rays, may cause degradation of the photosensitive polymer or an imidization reaction on an unintentional timing. Therefore, when the second additive having such a large amount of heat generation is used, it is desirable to adopt the structure shown in the present embodiment.

On the other hand, in the configuration of the present embodiment, it is not recommended to use the third additive as the additive. This is because the additive and the photosensitive polymer have to be close to each other in order to transfer the energy on the basis of the Foerster mechanism between the additive and the photosensitive polymer, and as a result, the field of the second reaction is limited to the vicinity of the interface between the low-concentration layer and the high-concentration layer so as to reduce the reaction efficiency.

Meanwhile, in the present embodiment, only polarized ultraviolet irradiation is performed. However, when the absorption wavelength band of the additive is different from the absorption wavelength band of the photosensitive polymer, the light in accordance with each of the absorption wavelength may be irradiated. The polarized ultraviolet rays that is the light to be irradiated to the photosensitive polymer and the light to be irradiated to the additive may be irradiated simultaneously or be irradiated alternately, for example. Further, the polarized ultraviolet rays that is the light to be irradiated to the photosensitive polymer may be irradiated from the low-concentration layer side, and the light to be irradiated to the additive may be irradiated from the high-concentration layer side (substrate side).

Meanwhile, in the present embodiment, when the high-concentration layer and the low-concentration layer are formed, the high-concentration layer is formed and, thereafter, the low-concentration layer is formed in a step-by-step manner. However, other methods may be adopted. For example, an additive having a functional group that is adsorbed or bonded to a substrate is used, and the substrate is coated with a varnish containing the photosensitive polymer and the additive. Thereafter, the substrate is made to react with the functional group included in the additive so as to localize the additive on the surface of the substrate. Subsequently, the alignment film is formed by the above-described method. In this case, the additive localized on the surface of the substrate also functions as a high-concentration layer.

### Fifth Embodiment

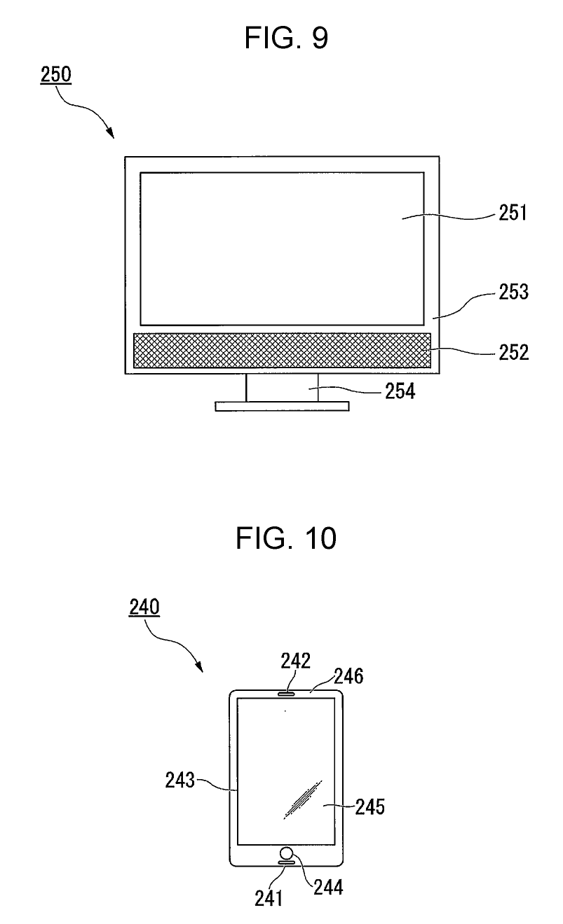

FIG. 9 to FIG. 11 are schematic diagrams showing electronic devices according to the present embodiment. The electronic devices according to the present embodiment include the above-described liquid crystal panel.

A low-profile television 250 shown in FIG. 9 includes a display portion 251, a speaker 252, a cabinet 253, a stand 254, and the like. The above-described liquid crystal panel can be favorably applied to the display portion 251. Consequently, the alignment film has a high alignment regulation force, and a high-quality image can be displayed.

A smart phone 240 shown in FIG. 10 includes a voice input portion 241, a voice output portion 242, a control switch 244, a display portion 245, a touch panel 243, a casing 246, and the like. The above-described liquid crystal panel can be favorably applied to the display portion 245. Consequently, the alignment film has a high alignment regulation force, and a high-quality image can be displayed.

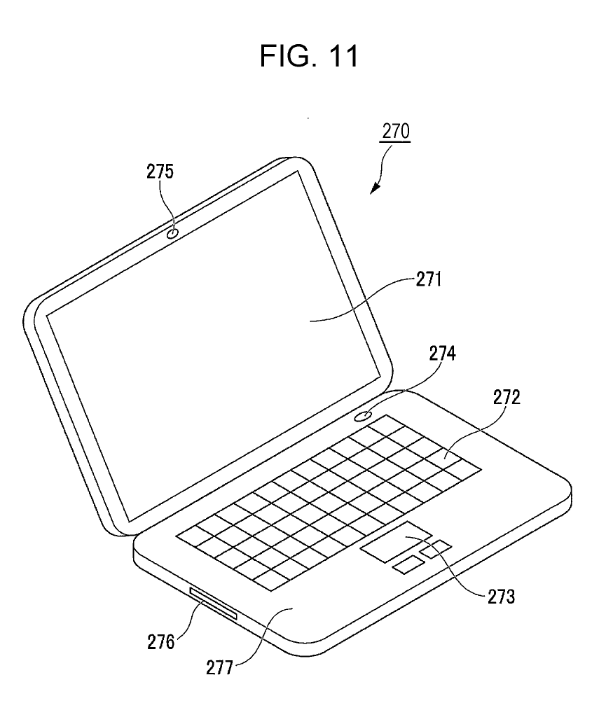

A notebook personal computer 270 shown in FIG. 11 includes a display portion 271, a keyboard 272, a touch pad 273, a main switch 274, a camera 275, a recording medium slot 276, a casing 277, and the like. The above-described liquid crystal panel can be favorably applied to the display portion 271. Consequently, the alignment film has a high alignment regulation force, and a high-quality image can be displayed.

Up to this point, preferred embodiments according to the present invention have been described with reference to the attached drawings. However, it is needless to say that the present invention is not limited to these examples. Various shapes, combinations, and the like of constituent members shown in the above-described examples are exemplifications, and various modifications can be made in accordance with design requirements and the like within the bounds of not departing from the gist of the present invention.

### EXAMPLES

An aspect of the present invention will be described below with reference to the examples, but the present invention is not limited to these examples.

### Example 1

Initially, a polyamic acid including an azobenzene portion in the main chain (first polymer) and a non-photosensitive polyamic acid were dissolved into a 3:1 mixed solvent (volume ratio) of NMP and butyl cellosolve. At this time, the concentration of the total polymer in the resulting solution was adjusted to become 3% by mass.

Subsequently, the additive in an amount of 1% by mass relative to the total amount of the polymer in the solution was added, and additive was dissolved by performing agitation so as to produce a varnish. Regarding the additive, 6,8-difluoro-7-hydroxy-4-methylcoumarin that had a main absorption band at a wavelength of 358 nm and that emitted light with a wavelength of 405 nm was used.

Then, a TFT substrate was prepared by a method in the related art. In the TFT substrate used, the number of pixels was 3,840 Pixel in the horizontal direction×2,160 Pixel in the vertical direction, and TFTs including an IGZO semiconductor layer and an FFS mode electrode structure were formed on a glass substrate having a substrate size of 13.5 inches and an aspect ratio of 16:9. A surface provided with the electrode structure of the substrate was spin-coated with the varnish (2,000 rpm and 20 seconds). Thereafter, the resulting coating film was prebaked at 70° C. for 3 minutes.

Next, the resulting coating film was irradiated with polarized ultraviolet rays from above the coating film by using a polarized light exposure apparatus provided with a 3-kW extra-high-pressure mercury lamp. The irradiated polarized ultraviolet rays were ultraviolet light in which short wavelengths of 300 nm or less were cut and which had an extinction ratio of 100:1 at 365 nm and an amount of light exposure of 2 J/cm².

Subsequently, the coating film irradiated with the polarized ultraviolet rays was heated in an inert oven at 110° C. for 20 minutes so as to enhance the alignment anisotropy of the polymer. Further, the coating film was heated at 230° C. for 40 minutes so as to imidize the polyamic acid and produce an alignment film.

The emission spectrum of the resulting alignment film was evaluated by an integrating hemisphere quantum yield measurement apparatus. As a result, when ultraviolet rays with a wavelength of 365 nm was irradiated, light emission at 450 nm was ascertained. When the light that caused the first reaction of the first polymer was irradiated to the composition of the first polymer and the additive used, conversion to the light that caused the second reaction of the first polymer was ascertained.

In addition, an alignment film was formed on a quartz substrate by the above-described method, and the polarized UV-vis absorption spectrum of the resulting alignment film was measured. In this regard, for the purpose of comparisons, an alignment film of a comparative example was formed in the same manner as in the above-described example except that no additive was used, and the polarized UV-vis absorption spectrum of the resulting alignment film was also measured.

As a result of the evaluation, it was found that the alignment film according to the present example had a large dichroic ratio at 365 nm, which was the absorption band of the azobenzene portion of the trans isomer, compared with the alignment film of the comparative example. Consequently, it was ascertained that the alignment film according to the present example had excellent alignment characteristics.

Then, a color filter substrate having columnar spacers (hereafter referred to as CF substrate) was prepared, and an alignment film was formed on a surface provided with the columnar spacers by the above-described method. Subsequently, the peripheral portion of the CF substrate was coated with a sealing agent, and the CF substrate and the alignment film of the TFT substrate were bonded so as to become opposite each other. Thereafter, a liquid crystal was injected between the CF substrate and the TFT substrate, and sealing was performed so as to produce a liquid crystal cell. The resulting liquid crystal cell was connected to electric wiring, and a polarizer and a backlight were disposed so as to produce a liquid crystal panel.

In addition, a liquid crystal panel of a comparative example was produced in the same manner as in the above-described example except that no additive was used.

In order to evaluate the alignment regulation force applied by the alignment film of the resulting liquid crystal panel to a liquid crystal material, the azimuthal anchoring strength was evaluated by using a torque balance method in accordance with NPL 1 (refer to Handbook of Thin Film Characterization Technology, p. 538, published in 2013). Hereafter azimuthal anchoring strength may be simply referred to as anchoring strength. An anchoring strength evaluation cell was separately prepared for evaluating the anchoring strength. The anchoring strength evaluation cell had a cell gap of about 25 μm and included the same alignment film as that used for the liquid crystal panel in the present example. The same liquid crystal material as that used for the liquid crystal panel in the present example was sealed into the anchoring strength evaluation cell, and evaluation was performed. At that time, S-811 serving as a chiral dopant was added to the liquid crystal material, and the chiral pitch was set to be 100 μm. The measurement was performed at 25° C.

As a result of evaluation, the liquid crystal panel of the present example had higher anchoring strength than the liquid crystal panel of the comparative example. The reason for this is considered to be that the alignment film used for the liquid crystal panel of the present example had higher dichroism and larger number of molecules intersecting the polarization axis than the alignment film used for the liquid crystal panel of the comparative example. Meanwhile, regarding the liquid crystal panel of the comparative example, disclination lines that indicated defective alignment were partly observed. However, no disclination line was observed in the liquid crystal panel of the present example and, therefore, it was ascertained that the alignment regulation force was enhanced.

### Example 2

Initially, a polyamic acid including a cyclobutane portion serving as a repeating structural unit in the main chain (precursor of second polymer) was dissolved into a 3:1 mixed solvent (volume ratio) of NMP and butyl cellosolve. At this time, the concentration of the total polymer in the resulting solution was adjusted to become 6% by mass. In this regard, the precursor of the second polymer included at least a structure obtained by reacting 1,3-dimethyl-1,2,3,4-cyclobutanetetracarboxylic acid with an aromatic diamine as a repeating structural unit.

Subsequently, the additive in an amount of 1% by mass relative to the total amount of the polymer in the solution was added, and additive was dissolved by performing agitation so as to produce a varnish. Regarding the additive, 4-diphenylbutadiyne that had a main absorption band at a wavelength of 305 nm and that emitted light with a wavelength of 330 nm was used.

Then, the same TFT substrate as that in example 1 was spin-coated with the varnish (4,700 rpm and 20 seconds). Thereafter, the resulting coating film was prebaked at 80° C. for 2 minutes.

Subsequently, the coating film was heated in an inert oven at 230° C. for 35 minutes so as to imidize the polyamic acid and produce a thin film of the polyamide (second polymer) including a cyclobutane portion.

Next, the resulting imide film was irradiated with polarized ultraviolet rays from above the imide film by using a polarized light exposure apparatus provided with a 3-kW extra-high-pressure mercury lamp. The irradiated polarized ultraviolet rays were ultraviolet light in which short wavelengths of 220 nm or less were cut and which had an extinction ratio of 50:1 at 254 nm and an amount of light exposure of 600 mJ/cm². In this manner, an alignment film was produced from the imide film.

The irradiation intensity at 305 nm in the radiation spectrum of the extra-high-pressure mercury lamp used was five times higher than the irradiation intensity at 254 nm. Consequently, when an additive that could utilize a wavelength of 305 nm was used, light with an efficiently converted wavelength could be generated compared with the case in which an additive that absorbed ultraviolet rays of 254 nm was used.

The emission spectrum of the resulting alignment film was evaluated by an integrating hemisphere quantum yield measurement apparatus. As a result, when ultraviolet rays with a wavelength of 305 nm was irradiated, light emission at 330 nm was ascertained. When the light that caused the first reaction of the second polymer was irradiated to the composition of the second polymer and the additive used, conversion to the light that caused the second reaction of the second polymer was ascertained.

In addition, an alignment film of the present example and an alignment film of a comparative example were formed in the same manner as in example 1, and the polarized UV-vis absorption spectra of the resulting alignment films were measured. As a result of the evaluation, it was found that the alignment film of the present example had a large dichroic ratio at 254 nm, which was the absorption band of an aromatic ring, compared with the alignment film of the comparative example. Consequently, it was ascertained that the alignment film of the present example had excellent alignment characteristics.

Subsequently, a liquid crystal panel was produced by the same method as in example 1. In addition, a liquid crystal panel of a comparative example was produced in the same manner as in the example except that no additive was used.

The anchoring strength of the resulting liquid crystal panel was evaluated in the same manner as in example 1. In addition, an AC afterimage and a voltage holding ratio (VHR) were measured by the methods described below.

The AC afterimage was evaluated by using a method described in, for example, NPL 2 (The Journal of the Institute of Electronics, Information and Communication Engineers, vol. J77-C-II, No. 9, pp 392-398, September, 1994). Regarding the AC afterimage, an alternating voltage was applied at 50° C. for 20 minutes and, thereafter, afterimage behavior was evaluated.

VHR was evaluated by using a method described in NPL 3 (Sharp Technical Journal, No. 92, pp 11-16, August, 2005). A voltage of 1 V was applied for 60 μsec, and a voltage decreasing rate after a lapse of 1 sec was assumed to be VHR. The measurement was performed at 60° C.

As a result of evaluation, it was found that the liquid crystal panel of the present example had higher anchoring strength than the liquid crystal panel of the comparative example because the alignment film applied a high alignment regulation force to liquid crystal molecules and had excellent AC afterimage and voltage holding ratio (VHR) characteristics because an amount of low-molecular-weight body was small.

### Example 3

Initially, a non-photosensitive polyamic acid was dissolved into a 3:1 mixed solvent (volume ratio) of NMP and butyl cellosolve. At this time, the concentration of the total polymer in the resulting solution was adjusted to become 6% by mass. In this regard, the non-photosensitive polyamic acid included a structure obtained by reacting pyromellitic acid with an aromatic diamine as a repeating structural unit in the main chain.

Subsequently, the additive in an amount of 2% by mass relative to the total amount of the polymer in the solution was added, and additive was dissolved by performing agitation so as to produce a varnish. Regarding the additive, 6,8-difluoro-7-hydroxy-4-methylcoumarin was used.

Meanwhile, the same polyamic acid including an azobenzene portion in the main chain (first polymer) as that in example 1 was dissolved into a 3:1 mixed solvent (volume ratio) of NMP and butyl cellosolve. At this time, the concentration of the total polymer in the resulting solution was adjusted to become 3% by mass.

Then, a TFT substrate prepared by a method in the related art was spin-coated with the varnish (4,700 rpm and 20 seconds) of the non-photosensitive polyamic acid so as to form a film.

Thereafter, the resulting coating film was prebaked at 80° C. for 2 minutes. Further, the coating film was heated in an inert oven at 230° C. for 35 minutes so as to imidize the polyamic acid and produce a high-concentration layer.

Then, the surface of the high-concentration layer was spin-coated with the varnish (2,000 rpm and 20 seconds) containing the first polymer so as to form a film. The resulting coating film was prebaked at 70° C. for 3 minutes.

Next, the resulting coating film was irradiated with the same polarized ultraviolet rays as that in example 1 from above the coating film by using a polarized light exposure apparatus provided with a 3-kW extra-high-pressure mercury lamp so as to form an alignment film. The amount of light exposure of the irradiated ultraviolet rays were set to be two levels of 2 J/cm² and 1.5 J/cm². Subsequently, firing was performed in the same manner as in example 1 so as to imidize the polyamic acid and produce an alignment film.

The resulting alignment film was subjected to an evaluation of emission spectrum and an evaluation of dichroism by the same methods as in example 1. As a result, the case in which the evaluation was performed under the condition of the amount of light exposure of 1.5 J/cm² was equivalent to the case in which the evaluation was performed under the condition of the amount of light exposure of 2 J/cm². Meanwhile, the dichroism of the case in which the evaluation was performed under the condition of the amount of light exposure of 2 J/cm² in the present example was slightly enhanced compared with the case in which the evaluation was performed under the condition of the amount of light exposure of 2 J/cm² in example 1, but there was not much difference. That is, in the present example, regarding the irradiated polarized ultraviolet rays, the proportion of the polarized ultraviolet rays absorbed by the additive is small and the photosensitive polymer could sufficiently absorb the polarized ultraviolet rays. Consequently, it was indicated that even when the amount of light exposure was as small as 1.5 J/cm², the first reaction and the second reaction occurred and the molecular chains had sufficient alignment anisotropy.

Subsequently, a liquid crystal panel was produced by the same method as in example 1. The anchoring strength and the voltage holding ratio (VHR) of the resulting liquid crystal panel were measured by using methods in the related art.

As a result of evaluation, in each of the case in which the amount of light exposure was 1.5 J/cm² and the case in which the amount of light exposure was 2 J/cm², the liquid crystal panel of the present example had anchoring strength equivalent to the anchoring strength of the liquid crystal panel of example 1.

In addition, it was ascertained that in each of the case in which the amount of light exposure was 1.5 J/cm² and the case in which the amount of light exposure was 2 J/cm², the liquid crystal panel of the present example had improved VHR characteristics compared with the liquid crystal panel of example 1. It was indicated that when the liquid crystal layer and the layer containing the additive were separated, as in the present example, isolation or elution of the additive into the liquid crystal layer was suppressed, leakage of charge in the liquid crystal layer was suppressed, and therefore, an alignment film having good VHR characteristics was produced.

### Example 4

Initially, a polymer solution of a non-photosensitive polyamic acid was prepared, as in example 3. Further, the additive in an amount of 5% by mass relative to the total amount of the polymer in the solution was added, and additive was dissolved by performing agitation so as to produce a varnish. Regarding the additive, 2-(2-benzotriazolyl)-p-cresol serving as the second additive was used.

Thereafter, a high-concentration layer was produced by the same method as in example 3. Then, the surface of the high-concentration layer was spin-coated with the same varnish containing the first polymer as that in example 3, and prebaking was performed so as to form a coating film.

Next, the resulting coating film was irradiated with the same polarized ultraviolet rays as that in example 1 from above the coating film by using a polarized light exposure apparatus provided with a 3-kW extra-high-pressure mercury lamp so as to form an alignment film. The amount of light exposure of the irradiated ultraviolet rays was set to be 2 J/cm².

The substrate temperature during exposure was 60° C. Meanwhile, when a substrate provided with a coating film in the same manner except that no second additive was used was subjected to exposure, the substrate temperature during exposure was 30° C. Consequently, an increase in the substrate temperature due to ultraviolet irradiation during exposure was also ascertained. Subsequently, firing was performed in the same manner as in example 1 so as to imidize the polyamic acid and produce an alignment film.

The resulting alignment film was subjected to an evaluation of emission spectrum and an evaluation of dichroism by the same methods as in example 1, and results equivalent to the results of the alignment film of example 1 were obtained.

Subsequently, a liquid crystal panel was produced by the same method as in example 1. In addition, a liquid crystal panel of a comparative example was produced in the same manner as in the example except that no additive was used. The anchoring strength and the voltage holding ratio (VHR) of the resulting liquid crystal panel were measured by using methods in the related art.

As a result of evaluation, the liquid crystal panel of the present example had higher anchoring strength than the liquid crystal panel of the comparative example. Consequently, it was ascertained that the alignment film of the present example had a higher alignment regulation force than the alignment film of the comparative example. In addition, regarding VHR, it was ascertained that when the layer containing the additive and the liquid crystal layer were separated, isolation or elution of the additive into the liquid crystal layer was suppressed, and therefore, a good VHR value was exhibited.

It was ascertained from the above-described results that the embodiments according to the present invention were useful.

### INDUSTRIAL APPLICABILITY

Some aspects of the present invention can be irradiated to a composition required to be capable of readily forming an alignment film that has a high alignment regulation force, a liquid crystal panel, a liquid crystal display device, an electronic device, and the like.

### REFERENCE SIGNS LIST

10 substrate
20, 112, 114, 122, 124 alignment film
100A, 100B liquid crystal panel
111 TFT substrate (a pair of substrates)
121 color filter substrate (a pair of substrates)
130 liquid crystal layer
240 smart phone (electronic device)
250 low-profile television (electronic device)
270 notebook personal computer (electronic device)
600, 700 liquid crystal display device

1. A composition comprising a photosensitive polymer in which the molecular structure changes due to absorption of light or a precursor of the photosensitive polymer; and
an additive that absorbs at least ultraviolet rays and that provides the energy of the absorbed ultraviolet rays to the photosensitive polymer,
wherein the photosensitive polymer absorbs at least some of the ultraviolet rays when specifically polarized ultraviolet rays are irradiated as the light so as to undergo a first reaction that generates anisotropy in the molecular alignment of the photosensitive polymer in accordance with the polarization direction of the polarized light and
a second reaction that further enhances the anisotropy generated in the molecular alignment of the photosensitive polymer by the first reaction, and
the additive absorbs the irradiated ultraviolet rays so as to convert the ultraviolet rays to energy for causing the second reaction and provide the resulting energy to the photosensitive polymer.

2. The composition according to claim 1, wherein the additive absorbs light in a first wavelength band, converts the absorbed light in the first wavelength band to light in a second wavelength band so as to promote the second reaction, and emits the light.

3. The composition according to claim 1, wherein the additive absorbs the light in the first wavelength band so as to generate heat.

4. The composition according to claim 1, wherein the additive absorbs the light in the first wavelength band and transfers the energy of the absorbed light in the first wavelength band on the basis of the Foerster mechanism between the additive and the photosensitive polymer.

5. The composition according to claim 2, wherein the additive absorbs light, as the light in the first wavelength band, that causes the first reaction and provides the energy to the photosensitive polymer.

6. The composition according to claim 2, wherein the additive absorbs light, as the light in the first wavelength band, in a wavelength band different from the wavelength band of the light that causes the first reaction and provides the energy to the photosensitive polymer.

7. The composition according to claim 1, wherein the photosensitive polymer undergoes a photoisomerization reaction as the first reaction.

8. The composition according to claim 1, wherein the photosensitive polymer undergoes a photodecomposition reaction as the first reaction.

9. A liquid crystal panel comprising:
a pair of substrates;
a liquid crystal layer interposed between the pair of substrates; and
an alignment film disposed on a liquid-crystal-layer-side surface of each of the pair of substrates,
wherein at least one of the alignment films included in the pair of substrates is formed of the composition according to claim 1.

10. The liquid crystal panel according to claim 9, wherein the alignment film formed of the composition includes a portion in which the concentration of the additive increases from the surface of the alignment film in the thickness direction of the alignment film.

11. A liquid crystal display device comprising the liquid crystal panel according to claim 9.

12. An electronic device comprising the liquid crystal panel according to claim 9.
